(19) United States
(12) Patent Application Publication
(10) Pub. No.: US 2009/0121109 A1
(43) Pub. Date: May 14, 2009

(54) Display stand for action figure

(76) Inventors: Richard C. Kinmont, Ogden, UT (US); Alexander R. Kinmont, Ogden, UT (US); Patrik A. Kinmont, Ogden, UT (US); Matthew T. Kinmont, Ogden, UT (US)

Correspondence Address: Michael R. Schramm, 350 West 2000 South, Perry, UT, 84302, US

(21) Appl. No.: 11/326,716

(22) Filed: Jan. 7, 2006

(51) Int. Cl. A47B 91/00; F21V 21/00

(52) U.S. Cl. 248/346.03; 362/249.08

(57) ABSTRACT

The Improved display stand is an invention that because of its unique adjustable overhead type lights and because of it unique electroluminescent lighting provides a stand that not only accommodates the display of various action figures or the like bathed in figure appropriate lighting, but creates an intriguing luminescent display. The display stand has particular application in the display of action type figures such as figures of characters know to science fiction type movies, wherein the display of such figures is enhanced due to adjustable lighting and due to the electroluminescent structural members of both the stand and the displayed item.

### BACKGROUND OF THE INVENTION

The present invention relates to display stands for action figures or the like. More particularly, the present invention relates to improved display stands having light cast upon a figure placed upon the stand and to stands having light emitting from select portions of the stand.

### SUMMARY OF THE INVENTION

The present invention is an improved display stand for action figures or like dolls and related displayable items. The stand, having adjustable lighting arms, is adaptable to optimally cast light on a variety of different action figures which may be displayed thereon. The stand further includes a portion of the stand structure that defines a light emitting portion of the stand. In the preferred embodiment, an action figure that includes as a portion of the action figure structure, electroluminescent members, is mounted on the structure. The electroluminescent members preferably include electroluminescent strands such as the electroluminescent strands disclosed in U.S. Pat. No. 5,869,930. U.S. Pat. No. 5,869,930 is expressly incorporated herein by reference.

It is well know that display stands, including stands that emit light, have long existed. Some samples of such display stands include the stands disclosed in U.S. Pat. No. 6,640,474, and published US patent application 20030140535. U.S. Pat. No. 6,640,474, and published US patent application 20030140535 are expressly incorporated herein by reference. However, such prior art display stands have been of the type that do not provide for adjustable lighting, that do not include electroluminescent material built into the display stand structure, and that do not include electroluminescent material as a portion of the structure of the item displayed on the stand.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a substantially front view of the improved display stand assembly.

FIG. 2 is a schematic view of the electrical components of the improved display stand assembly.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature table is provided below. It is noted that like features are like numbered throughout all of the figures.

FEATURE TABLE

| # | Feature |
|---|---|
| 10 | Improved display stand assembly |
| 20 | Base assembly |
| 21 | Base housing |
| 22 | Base display platform |
| 23 | Glow ring |
| 24 | Glow ring support column |
| 25 | Female type electrical outlet |
| 26 | Speaker |
| 30 | Flexible Light assembly |
| 31 | Flexible arm |
| 32 | Spot light |
| 40 | Action figure figurine |
| 41 | Figurine foot |
| 42 | Figurine leg |
| 43 | Figurine torso |
| 44 | Figurine arm |
| 45 | Figurine hand |
| 46 | Light saber |
| 47 | Figurine head |
| 48 | Figurine power cord |
| 49 | Figurine power cord plug |
| 50 | Schematic diagram in general |
| 51 | Alternating current type electrical plug |
| 52 | Electrical power supply |
| 53 | Electrical switch |
| 54 | Potentiometer |
| 55 | Sound electrical chip |
| 56 | Sound activation button |
| 57 | A first electrically activated light |
| 58 | A second electrically activated light |
| 59 | Electrical line |

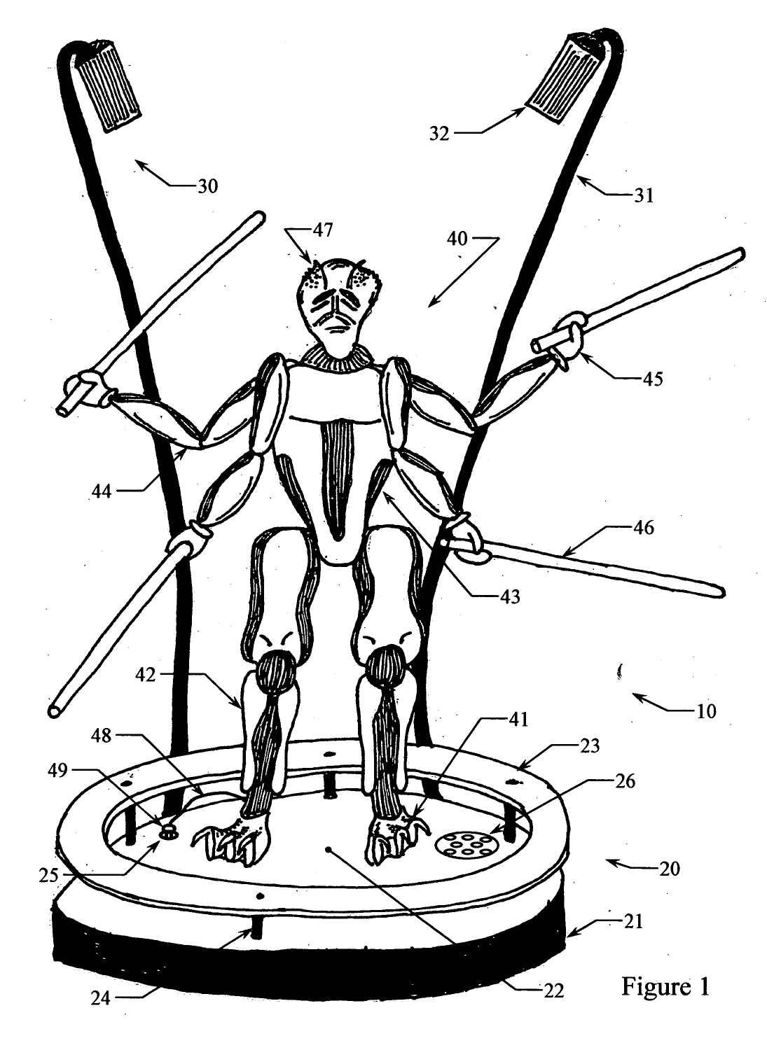

Referring now to the drawings and particularly to FIG. 1, the invention is improved display stand assembly 10 comprising a base assembly 20, a plurality of flexible light assemblies 30, and an action figure type figurine 40.

Base assembly 20 comprises a substantially cylindrically shaped base housing 21, a base display platform 22, a glow ring 23, a plurality of cylindrically shaped glow ring support columns 24, a female type electrical outlet 25, and a sound emitting electrical speaker 26. Base housing 21 defines a generally cylindrically shaped hollow housing shell. Base display platform defines a substantially disked shaped translucent member having a plurality of energized electroluminescent strands mounted to a lower surface of display platform 22. Display platform further includes female type electrical outlet 25 and sound emitting electrical speaker 26 retentatively connected to platform 22. Electrical outlet 25 is powered by electrical power such as by power from a standard 110 volt wall outlet with appropriate regulation of said power by a power regulator. Electrical outlet 25 is alternately powered by standard batteries such as flashlight type batteries. Base housing 21 is adapted so as to house a power supply and batteries. Speaker 26 and display platform 22 are further connected to a power supply such that speaker 26 emits predetermined sounds at predetermined times and such that the electroluminescent strands connected to platform 22 are energized. Platform 22 is further connected to a first end of support columns 24. A second end of support columns 24 is connected to glow ring 23. Glow ring 23, and support columns 24, like platform 22 are formed from a translucent material so as enable glow ring 23 to conduct and emit light.

Flexible light assembly 30 comprises a substantially flexible arm 31 and a spot light 32. Flexible light assembly 30 is adapted such that the position of spot light 32 is readily moveable by means of bending or otherwise reconfiguring flexible arm 31. Such positioning of spot light 32 enables unique and appealing lighting of the figurine 40 while figurine 40 is being displayed. Once positioned, flexible light assembly 30 maintains its position until it is again repositioned.

Action figure figurine 40 comprises a figurine foot 41, a figurine leg 42, a figurine torso 43, a figurine arm 44, a figurine hand 45, a light saber 46, a figurine head 47, a figurine power cord 48, and a figurine power cord plug 49. Figurine foot 41 is connected to figurine leg 42. Figurine leg 42 is connected to figurine torso 43. Figurine torso 43 is connected to figurine arm 44 and figurine head 47. Figurine arm 44 is connected to figurine hand 45. Figurine hand 45 is connected to light saber 46. Light saber 46 comprises an elongated substantially clear plastic tube connected to a handle and having electroluminescent strands energizably contained within said tube. Figurine 40, thus assembled defines a preferably formable and life-like repositionable figurine. Figurine 40 further includes power cord 48 having a first end connected to said figurine 40. Power cord 48 includes a power cord plug 49 connected to a second end of power cord 48.

In practice, display stand 10 is assembled such that light assemblies 30 are repositioningly connected to base 20 and figurine 40 is rested on base 20 with plug 49 connected to outlet 25. Further in practice, when base 20 is powered by an electrical power source such as power from a standard 110 volt electrical wall outlet or from flashlight type batteries, electroluminescent strands are energized, and base 20, including display platform 22, columns 24, and glow ring 23, light sabers 46, and spot light 32 emit light and cast light on surrounding objects. Further, when stand 10 is powered, stand 10 emits predetermined sounds, such as those sounds that might be associated with the select figurine. Stand 10 is adapted such that different figures may be substituted for depicted figurine 40 and such that when a different figurine is displayed, a different predetermined sound associated with the substituted figurine is emitted when stand 10 is electrically powered. It is noted that because a portion of the light emitted from stand 10 is created by energizing electroluminescent strands, the emitted light creates a realistic appearing light. For instance, when light saber 46 emits light, it appears as if light saber 46 glowing in the manner that a light sabers have appeared to glow in popular science fiction movies.

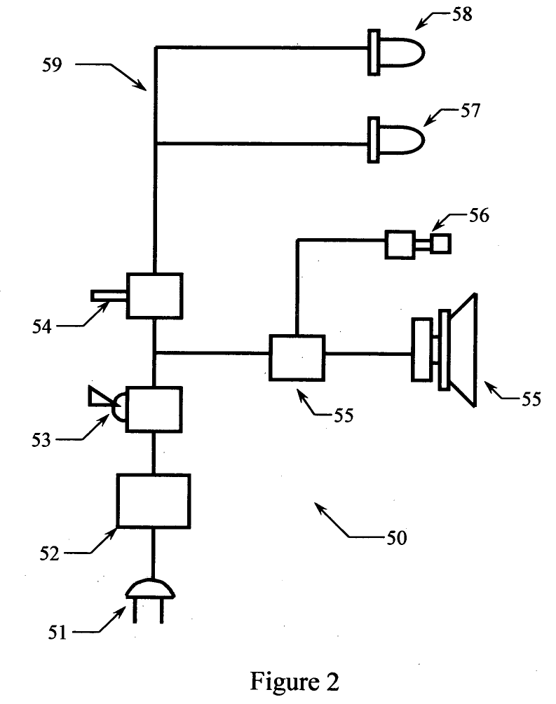

FIG. 2 is provided to display a sample electrical schematic diagram of the invention. In FIG. 2, diagram 50 symbolically displays alternating current type electrical plug 51, electrical power supply 52, electrical switch 53, potentiometer 54, sound electrical chip 55, sound activation button 56, a first electrically activated light 57, a second electrically activated light 58, and an electrical line 59. The components of the invention are electrically connected in the order depicted in diagram 50 of FIG. 2, such that the invention functions as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An improved display stand comprising a base having a display surface for supporting an item to be displayed, wherein said display surface comprises a substantially translucent member connected to at least one energized electroluminescent strand such that said display surface glows, and wherein said base includes a displayed object resting on said display surface, and wherein said displayed object is connected to a weapon.

2. The display stand of claim 1 wherein said stand includes at least one flexible and repositionable light emitting arm connected to said base, and wherein said repositionable light emitting arm further defines a flexible arm connected to a spot light and wherein said flexible arm is adapted to maintain a predetermined position until said flexible arm is repositioned.

3. The display stand of claim 1 wherein said displayed object comprises a plurality of connected structural members, and wherein at least one of said structural members defines an electroluminescent strand lighted member.

4. The display stand of claim 1 wherein said translucent member defines a clear plastic disk shaped member, and wherein said at least one electroluminescent strand defines a plurality of electroluminescent strands connected to said clear plastic disk shaped member.

5. The display stand of claim 1 wherein said stand includes at least one flexible and repositionable light emitting arm connected to said base, and wherein said displayed object defines a figurine connected to an electroluminescent strand lighted weapon, and wherein said translucent member defines a clear plastic disk shaped member, and wherein said at least one electroluminescent strand defines a plurality of electroluminescent strands connected to said clear plastic disk shaped member, and wherein said stand includes a sound emitting speaker connected to said stand, and wherein said repositionable light emitting arm further defines a flexible arm connected to a spot light and wherein said flexible arm is adapted to maintain a predetermined position until said flexible arm is repositioned.

6. An improved display stand comprising a base having a display surface for supporting an item to be displayed and at least one flexible and repositionable light emitting arm connected to said base, wherein said display surface comprises a substantially translucent member connected to at least one energized electroluminescent strand such that said display surface glows, and wherein said repositionable light emitting arm further defines a flexible arm connected to a spot light and wherein said flexible arm is adapted to maintain a predetermined position until said flexible arm is repositioned.

7. The display stand of claim 6 wherein said stand includes a displayed object resting on said base.

8. The display stand of claim 7 wherein said displayed object comprises a plurality of connected structural members, and wherein at least one of said structural members defines an electroluminescent strand member.

9. The display stand of claim 6 wherein said translucent member defines a clear plastic disk shaped member, and wherein said at least one electroluminescent strand defines a plurality of electroluminescent strands connected to said clear plastic disk shaped member.

10. The display stand of claim 6 wherein said stand includes a displayed object resting on said base, and wherein said displayed object defines a figurine connected to an electroluminescent strand lighted weapon, and wherein said translucent member defines a clear plastic disk shaped member, and wherein said at least one electroluminescent strand defines a plurality of electroluminescent strands connected to said clear plastic disk shaped member, and wherein said stand includes a sound emitting speaker connected to said stand.

11. An improved display stand comprising a base and at least one flexible and repositionable light emitting arm connected to said base, and wherein said base includes a displayed object resting on said base, and wherein said repositionable light emitting arm further defines a flexible arm connected to a spot light and wherein said flexible arm is adapted to maintain a predetermined position until said flexible arm is repositioned.

12. The display stand of claim 11 wherein said base includes a display surface, and wherein said display surface comprises a substantially translucent member connected to at least one energized electroluminescent strand such that said display surface glows.

13. The display stand of claim 12 wherein said translucent member defines a clear plastic disk shaped member, and wherein said at least one electroluminescent strand defines a plurality of electroluminescent strands connected to said clear plastic disk shaped member.

14. The display stand of claim 11 wherein said displayed object comprises a plurality of connected structural members, and wherein at least one of said structural members defines an electroluminescent strand lighted member.

15. The display stand of claim 11 wherein said displayed object defines a figurine connected to an electroluminescent strand lighted weapon, and wherein said base includes a display surface comprising a substantially clear plastic disk shaped translucent member connected to a plurality of energized electroluminescent strands such that said display surface glows, and wherein said stand includes a sound emitting speaker connected to said stand.

16. An improved display stand comprising a base having a displayed object resting thereon, wherein said displayed object comprises a plurality of connected structural members, and wherein at least one of said structural members defines an electroluminescent strand lighted weapon.

17. The display stand of claim 16 wherein said stand includes at least one flexible and repositionable light emitting arm connected to said base, and wherein said repositionable light emitting arm further defines a flexible arm connected to a spot light and wherein said flexible arm is adapted to maintain a predetermined position until said flexible arm is repositioned.

18. The display stand of claim 16 wherein said base includes a display surface comprising a substantially clear plastic disk shaped translucent member connected to a plurality of energized electroluminescent strands such that said display surface glows.

19. The display stand of claim 16 wherein said electroluminescent strand lighted weapon defines a light saber.

20. The display stand of claim 1 wherein said stand includes at least one flexible and repositionable light emitting arm connected to said base, and wherein said electroluminescent strand lighted weapon defines a light saber, and wherein said base includes a display surface comprising a substantially clear plastic disk shaped translucent member connected to a plurality of energized electroluminescent strands such that said display surface glows, and wherein said stand includes a sound emitting speaker connected to said stand, and wherein said repositionable light emitting arm further defines a flexible arm connected to a spot light and wherein said flexible arm is adapted to maintain a predetermined position until said flexible arm is repositioned.
